(19) United States
(12) Patent Application Publication
(10) Pub. No.: US 2023/0289223 A1
(43) Pub. Date: Sep. 14, 2023

(54) TASK SCHEDULING METHOD, GAME ENGINE, DEVICE AND STORAGE MEDIUM

(71) Applicant: Tencent Technology (Shenzhen) Company Limited, Shenzhen (CN)

(72) Inventors: Bowen YU, Shenzhen (CN); Wentao WANG, Shenzhen (CN)

(73) Assignee: Tencent Technology (Shenzhen) Company Limited, Shenzhen (CN)

(21) Appl. No.: 18/319,254

(22) Filed: May 17, 2023

Related U.S. Application Data
(63) Continuation of application No. PCT/CN2022/106410, filed on Jul. 19, 2022.

(30) Foreign Application Priority Data
Aug. 16, 2021 (CN) 202110941214.9

(51) Int. Cl. G06F 9/48; G06F 9/50

(52) U.S. Cl. CPC G06F 9/4881; G06F 9/5038

(57) ABSTRACT

Embodiments of this application relate to a game engine including a task scheduling system and a plurality of task processing systems. Each task processing system is configured with a corresponding task processing stage and a running association relationship in the corresponding task processing stage. The running association relationship is used for representing a running dependency relationship between the task processing system and other task processing systems. Specific task processing systems respectively generate, during the game engine working in a pending stage, to-be-executed tasks which are to be processed by the specific task processing systems, and transmit the to-be-executed tasks to the task scheduling system. The task scheduling system allocates processing threads in a central processing unit (CPU) for the to-be-executed tasks based on load conditions of the processing threads in the CPU and running association relationships of the specific task processing systems in the pending stage.

### RELATED APPLICATION

This application is a continuation of PCT Application No. PCT/CN2022/106410 filed on Jul. 19, 2022 which claims priority to Chinese Patent Application No. 202110941214.9, entitled “TASK SCHEDULING METHOD, GAME ENGINE, DEVICE, AND STORAGE MEDIUM” and filed with the National Intellectual Property Administration, PRC on Aug. 16, 2021. Both of these applications are incorporated herein by reference.

### FIELD OF THE TECHNOLOGY

This application relates to the technical field of computers, and in particular to a task scheduling method, a game engine, a device, and a storage medium.

### BACKGROUND OF THE DISCLOSURE

Game engines generally refer to well-written editable game systems, or core components of real-time interactive image application programs, and provide game designers with various tools needed to write game programs, so that the game designers can quickly make game programs. The game engines generally support the following functions: physical computing, light and shadow effect determination, collision detection, game element rendering, sound effect generation, and game script running, etc. During running of the game engines, the various functions supported by the game engines work in conjunction to realize normal running of games.

When a currently common game engine runs on a multi-core central processing unit (CPU), it is generally difficult to achieve overall control on CPU parallelism, and the degree of CPU parallelism may be high in certain periods and low in other periods, which can easily cause problems such as a drop in frame rate of a game, and heating and increased consumption of the CPU.

### SUMMARY

Embodiments of this application provide a task scheduling method, a game engine, a device, and a storage medium, capable of realizing overall control on CPU parallelism, improving the frame rate of a game, and reducing heating and consumption of a CPU.

A first aspect of this application provides a task scheduling method, executed by a terminal device, the terminal device being configured to support running of a game engine including a task scheduling system and a plurality of task processing systems; tasks to be processed by the plurality of task processing systems respectively being different, each task processing system being configured with a corresponding task processing stage and a running association relationship of the task processing system in the corresponding task processing stage, and the running association relationship being used for representing a running dependency relationship between the task processing system and other task processing systems in the game engine; the method including:

generating, respectively by specific task processing systems during the game engine working in a pending stage, to-be-executed tasks which are to be processed by the specific task processing systems, and transmitting the to-be-executed tasks to the task scheduling system, each specific task processing system being a task processing system a configured task processing stage of which is the pending stage in the game engine; and

allocating, by the task scheduling system for the to-be-executed tasks from the specific task processing systems, processing threads in a CPU for the to-be-executed tasks based on load conditions of the processing threads in the CPU and running association relationships of the specific task processing systems in the pending stage.

A second aspect of this application provides a game engine, running on a terminal device, and including a task scheduling system and a plurality of task processing systems, tasks to be processed by the plurality of task processing systems respectively being different, each task processing system being configured with a corresponding task processing stage and a running association relationship of the task processing system in the corresponding task processing stage, and the running association relationship being used for representing a running dependency relationship between the task processing system and other task processing systems in the game engine;

the task processing systems being configured to generate, during the game engine working in the task processing stages corresponding to the task processing systems, tasks which are to be processed by the task processing systems, and transmit the tasks to the task scheduling system; and

the task scheduling system being configured to allocate, for to-be-executed tasks from specific task processing systems during the game engine working in the pending stage, processing threads in a CPU for the to-be-executed tasks based on load conditions of the processing threads in the CPU and running association relationships of the specific task processing systems in the pending stage, each specific task processing system being a task processing system a configured task processing stage of which is the pending stage in the game engine, and the to-be-executed task being a task which is generated and to be processed by the specific task processing system.

A third aspect of this application provides a device, including a processor and a memory,

the memory being configured to store a computer program; and

the processor being configured to execute, according to the computer program, steps of the task scheduling method according to the first aspect.

A fourth aspect of this application provides a computer-readable storage medium, configured to store a computer program, the computer program being configured to execute steps of the task scheduling method according to the first aspect.

A fifth aspect of this application provides a computer program product or a computer program, the computer program product or the computer program including a computer instruction, which is stored in a computer-readable storage medium. A processor of a computer device reads the computer instruction from the computer-readable storage medium, and executes the computer instruction, to enable the computer device to execute steps of the task scheduling method according to the first aspect.

According to the foregoing technical solutions, it can be learned that the embodiments of this application have the following advantages:

The embodiments of this application provide a task scheduling method, which provides a game engine-level processing resource scheduling manner, that is, in each task processing stage involved in a game running process, association relationships between tasks generated by a game engine in the task processing stage are comprehensively considered, and on this basis, the processing resources are allocated for the tasks reasonably. The task scheduling method provided by the embodiments of this application is applied to a game engine built based on an entity-component-system (ECS) architecture. This game engine decouples processing logics in a game, and respectively execute different tasks by using multiple independent task processing systems. This application innovatively configures, for each task processing system in the game engine, an applicable task processing stage of the task processing system, and a running association relationship of the task processing system in the applicable task processing stage, and additionally provides a task scheduling system, which is configured to comprehensively schedule processing resources, in the game engine. During the game engine working in a certain task processing stage, for example, a pending stage, the task scheduling system reasonably allocates, according to a running association relationship of a specific task processing system applicable to the pending stage, processing threads in a CPU to a to-be-executed task generated by the specific task processing system applicable to the pending stage, thereby implementing processing resource configuration based on a game engine level. Therefore, allocating processing resources by comprehensively considering a running dependency relationship between one task processing system and other task processing systems in a game engine can realize overall control on CPU parallelism, so that the frame rate of a game is improved, and heat loss of a CPU is reduced.

### BRIEF DESCRIPTION OF THE DRAWINGS

FIG. 1 is a schematic diagram of an application scenario of a task scheduling method according to an embodiment of this application.

FIG. 2 is a schematic diagram of a working principle of a game engine according to an embodiment of this application.

FIG. 3 is a schematic diagram of an execution sequence of a preUpdate stage, an Update stage and a postUpdate stage according to an embodiment of this application.

FIG. 4 is a schematic flowchart of a task scheduling method according to an embodiment of this application.

FIG. 5 is a schematic diagram of an execution process of a task scheduling system according to an embodiment of this application.

FIG. 6 is a schematic diagram of occupancy of processing resources of a CPU during running, based on a task scheduling method according to an embodiment of this application, of a game engine according to an embodiment of this application.

FIG. 7 is a schematic structural diagram of a game engine according to an embodiment of this application.

FIG. 8 is a schematic structural diagram of a terminal device according to an embodiment of this application.

### DETAILED DESCRIPTION

In order to enable a person skilled in the art to better under the solutions of this application, the following clearly and completely describes the technical solutions of the embodiments of this application with reference to the accompanying drawings in the embodiments of this application. The described embodiments are merely some rather than all of the embodiments of this application. All other embodiments obtained by persons of ordinary skill in the art based on the embodiments of this application without creative efforts fall within the scope of protection of this application.

In this specification, claims, and accompanying drawings of this application, the terms “first”, “second”, “third”, “fourth”, and so on (if it exists) are intended to distinguish similar objects but do not necessarily indicate a specific order or sequence. It is to be understood that such used data is interchangeable where appropriate so that the embodiments of this application described here can be implemented in an order other than those illustrated or described here. Moreover, the terms “include”, “contain” and any other variants mean to cover the non-exclusive inclusion, for example, a process, method, system, product, or device that includes a list of steps or units is not necessarily limited to those expressly listed steps or units, but may include other steps or units not expressly listed or inherent to such a process, method, system, product, or device.

In the related art, during the running of a game engine, generally attention is only paid to scheduling situations of processing resources on a task level, that is, processing resources are only configured for sub-tasks in a currently executed task, and configuration of the processing resources are not performed from the perspective of overall running of the game engine. Therefore, overall control on CPU parallelism cannot be realized, and problems such as a drop in frame rate of a game, and a reduction of heat generation of a CPU may easily be caused.

With regard to the problems in the related art, an embodiment of this application provides a task scheduling method. The method realizes overall control on CPU parallelism, so that the frame rate of a game is improved, and heating and consumption of a CPU are reduced.

Exemplarily, the task scheduling method according to the embodiment of this application is applied to a game engine based on an ECS architecture. The game engine includes a task scheduling system and a plurality of task processing systems. Tasks to be processed by the plurality of task processing systems respectively are different. Each task processing system is configured with a corresponding task processing stage and a running association relationship of the task processing system in the corresponding task processing stage. The running association relationship is used for representing a running dependency relationship between the task processing system and other task processing systems in the game engine. Specific task processing systems respectively generate, during the game engine working in a pending stage, to-be-executed tasks which are to be processed by the specific task processing systems, and transmit the generated to-be-executed tasks to the task scheduling system. Here, each specific task processing system is a task processing system, the task processing stage of which is the pending stage, in the game engine. The task scheduling system allocates, for the to-be-executed tasks from the specific task processing systems, processing threads in a CPU for the to-be-executed tasks based on load conditions of the processing threads in the CPU and running association relationships of the specific task processing systems in the pending stage.

The task scheduling method provides a game engine-level processing resource scheduling manner, that is, in each task processing stage involved in a game running process, running association relationships between tasks generated by the game engine in the task processing stage are comprehensively considered, and on this basis, the processing resources are allocated for the tasks reasonably. The task scheduling method is applied to a game engine built based on an ECS architecture. This game engine decouples processing logics in a game, and respectively executes different tasks by using multiple independent task processing systems. Based on the game engine, this application innovatively configures, for each task processing system in the game engine, an applicable task processing stage of the task processing system, and a running association relationship of the task processing system in the applicable task processing stage, and additionally provides a task scheduling system, which is configured to comprehensively schedule processing resources, in the game engine. While the game engine is working in a certain task processing stage, for example a pending stage, the task scheduling system reasonably allocates, according to a running association relationship of a specific task processing system applicable to the pending stage, processing threads in a CPU to a to-be-executed task generated by the specific task processing system applicable to the pending stage, thereby implementing processing resource configuration based on a game engine level. Therefore, allocating processing resources by comprehensively considering a running dependency relationship between one task processing system and other task processing systems in a game engine can realize overall control on CPU parallelism, so that the frame rate of a game is improved, and heat loss of a CPU is reduced.

It is to be understood that the task scheduling method according to the embodiment of this application is applied to a terminal device supporting running of the game engine. The terminal device specifically may be a smart phone, a computer, a tablet computer, a personal digital assistant (PDA), and a vehicle-mounted terminal, etc. Terminal devices applicable for the task scheduling method are not limited in this application.

In order to facilitate understanding of the task scheduling method according to the embodiment of this application, an application scenario of the task scheduling method according to the embodiment of this application is described exemplarily.

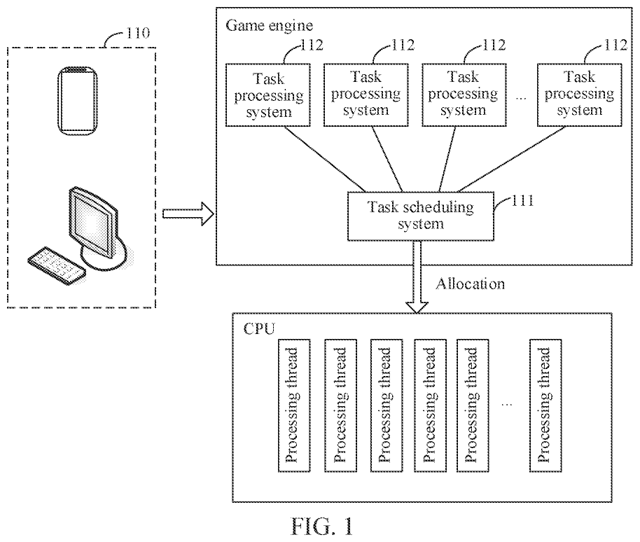

With reference to FIG. 1, FIG. 1 is a schematic diagram of an application scenario of a task scheduling method according to an embodiment of this application. As shown in FIG. 1, a terminal device 110 is included in the application scenario. The terminal device 110 may be a device supporting running of a game application program, such as a smart phone and a computer. The terminal device 110 shown in FIG. 1 is merely an example. The game application program runs in the terminal device 110. During running of the game application program, various parts in the game engine work in conjunction to realize various functions of the game application program.

The game engine of the game application program running in the terminal device 110 includes a task scheduling system 111 and a plurality of task processing systems 112. The task scheduling system 111 is configured to allocate, during running of the game engine, processing threads in a CPU for tasks generated by the task processing systems 112 in the game engine. The task processing systems 112 are configured to generate, during the running of the game engine, tasks to be processed by the task processing systems 112. The tasks to be processed by the task processing systems 112 respectively are different. In one possible implementation, the game engine of the game application program running in the terminal device 110 may be a game engine based on an ECS architecture.

In the embodiment of this application, when a task processing system 112 is registered in the game engine, an applicable task processing stage needs to be configured for the task processing system 112 as the task processing stage corresponding to the task processing system 112. Exemplarily, the task processing stages are divided according to processing of a game frame in a game, for example, the processing of the game frame is divided into a preUpdate stage, an Update stage and a postUpdate stage. Accordingly, when the task processing system 112 is registered in the game engine, the task processing system 112 can be configured to be specifically applicable to which stage or which stages of the preUpdate stage, the Update stage the postUpdate stage. In addition, when the task processing system 112 is registered in the game engine, a running association relationship of the task processing system 112 in the corresponding task processing stage is configured for the task processing system 112. The running association relationship is used for representing a running dependency relationship between the task processing system 112 and other task processing systems 112 in the game engine. For example, for a task processing system configured to execute a rendering task, the task processing system needs to execute the rendering task depending on a processing result of a task processing system configured to execute a physical computing task. Accordingly, when the task processing system configured to execute the rendering task is registered in the game engine, a running association relationship of the task processing system is configured based on the working relationship.

In an actual running process of the game application program, specific task processing systems respectively generate, during the game engine working in a pending stage, to-be-executed tasks which are to be processed by the specific task processing systems, and transmit the generated to-be-executed tasks to the task scheduling system 111. Each specific task processing system is a task processing systems 112, the configured task processing stage of which is the pending stage, in the game engine. For example, when the game engine works to the preUpdate stage (i.e., the pending stage) corresponding to a certain game frame, the task processing system, the configured task processing stage of which is the preUpdate stage, in the game engine is the specific task processing system.

The task scheduling system 111 receives the to-be-executed tasks from the specific task processing systems, and allocates, for the to-be-executed tasks from the specific task processing systems, processing threads in a CPU for the to-be-executed tasks based on load conditions of the processing threads in the CPU, which is configured to support running of the game application program, in the terminal device 110 and running association relationships of the specific task processing systems in the pending stage. In response to the CPU supporting running of the game application program being a homogeneous multi-core CPU, the task scheduling system 111 allocates the processing threads in the CPU for the to-be-executed tasks based on a load balancing principle of processing threads in a CPU. In response to the CPU supporting running of the game application program being a heterogeneous multi-core CPU, the task scheduling system 111 allocates the processing threads in the CPU for the to-be-executed tasks by comprehensively considering data processing capabilities of cores in a CPU.

It is to be understood that the application scenario as shown in FIG. 1 is merely an example. In actual application, the task scheduling method according to the embodiment of this application can further be applied to other scenarios. Applicable application scenarios of the task scheduling method according to the embodiment of this application are not limited in this application.

In order to facilitate understanding of the task scheduling method according to the embodiment of this application, before the task scheduling method according to the embodiment of this application is described, the game engine applicable to the task scheduling method is described first. With reference to FIG. 2, FIG. 2 is a schematic diagram of a working principle of a game engine applicable to the task scheduling method according to an embodiment of this application.

As shown in FIG. 2, the game engine applicable to the task scheduling method according to the embodiment of this application is a game engine based on an ECS architecture. The pattern of ECS architecture follows the principle of favoring composition over inheritance. In the ECS architecture, each basic unit in a game can be considered as one entity. The basic unit in the game here is understood as each independent virtual element in the game. The virtual elements may be various elements appearing in a game world, such as a virtual role, a virtual prop and a virtual decorative element in the game world. Each entity includes at least one type of component data. Each component data is essentially functional property data of a virtual element corresponding to the entity to which the component data belongs. The component data generally merely includes description data about a function attribute, and does not include any method logic data. A system in the ECS architecture, i.e., the task processing system in the embodiment of this application, is a tool configured to operate a virtual element corresponding to an entity according to component data included in the entity. The system merely has behaviors, not any status data.

The entity in the ECS architecture is actually a conceptual definition, used for referring to a virtual element existing in the game, and includes at least one type of component data. In order to distinguish different virtual elements in the game, a unique identity document (ID) is configured for each entity in a code level, and all component data included in the entity is also marked by the ID corresponding to the entity, so that the ownership relationship between the component data and the entity is clarified. As shown in FIG. 2, in the game engine, the entities in the game engine are generally managed by an entity manager, to execute the operation of configuring an ID.

Because an entity in the ECS architecture is a set of component data, during running of the game engine, the component data in the entity can be conveniently dynamically edited, for example, adding new component data to the entity, or deleting component data from the entity. For example, assuming that a virtual role controlled by a player loses a moving function due to certain reasons, the game engine can simply delete component data used for describing the moving capability from the entity corresponding to the virtual role, so that an effect that the virtual role cannot move is achieved.

The component data in the ECS architecture is functional property data of the virtual element corresponding to the entity to which the component data belongs. The component data is merely used for storing a status, and does not represent any behavior. The component data included in the entity can describe a function owned by the virtual element corresponding to the entity. For example, assuming that one entity includes position component data, it means that the virtual element corresponding to the entity occupies a certain regional position in the game world. For another example, assuming that one entity includes component data related to a moving function, it means that the virtual element corresponding to the entity has a moving capability. As shown in FIG. 2, in the game engine, the component data of the entities in the game engine is generally managed by a component manager. The component manager may allocate a memory and a controller for component data, and manages all the component data in the game engine.

The system (i.e., the task processing system in the embodiment of this application) in the ECS architecture is an execution tool of a game logic. The system can operate an entity owning component data. The system can merely execute a behavior, and does not store any status data. In the ECS architecture, in order to independently realize various game logics, various game logics supported by the game are decoupled, and allocated to different task processing systems. That is, different task processing systems execute different game logics. During execution of tasks to be processed by the task processing systems, the task processing systems traverse the component data of the entities in the game engine, determine entities related to the tasks to be processed by the task processing systems, and thus execute the corresponding tasks based on the component data in the entities. For example, the task processing system configured to realize a moving function can traverse all the entities in the game engine, so as to find an entity having component data related to the moving function, and thus based on the component data related to the moving function in the entity, control a virtual element corresponding to the entity to move. As shown in FIG. 2, in the game engine, the task processing systems in the game engine are generally managed by a system manager. The system manager can control the task processing systems to execute corresponding game logics, and operate virtual elements in the game based on the component data included in the entities. In addition, the game engine further realizes interaction of messages between the task processing systems by means of an event manager.

On the basis of the game engine based on the ECS architecture described above, the embodiment of this application further adds the task scheduling system configured to schedule processing resources for tasks generated during running of the game engine. A specific working manner of the task scheduling system is described in detail in the following method embodiments.

In addition, on the basis of the game engine based on the ECS architecture described above, the embodiment of this application further configures, for the task processing systems in the game engine, corresponding task processing stages and running association relationships of task processing systems in the corresponding task processing stages. The running association relationship is used for representing a running dependency relationship between the task processing system and other task processing systems in the game engine.

In one possible implementation, the embodiment of this application can divide, according to an actual working manner of the game engine, processing of the game engine into multiple task processing stages. When a task processing system is registered in the game engine, a task processing stage applicable to a task to be processed by the task processing system is determined, and serves as a task processing stage corresponding to the task processing system.

Exemplarily, the task processing stage in the embodiment of this application is divided according to processing of a game frame, and the divided task processing stage includes a preUpdate stage, an Update stage and a postUpdate stage corresponding to the game frame. The preUpdate stage is used for executing a preparation task required for updating the game frame, the Update stage is used for executing an update task of the game frame, and the postUpdate stage is used for executing a finishing task required after the game frame is updated.

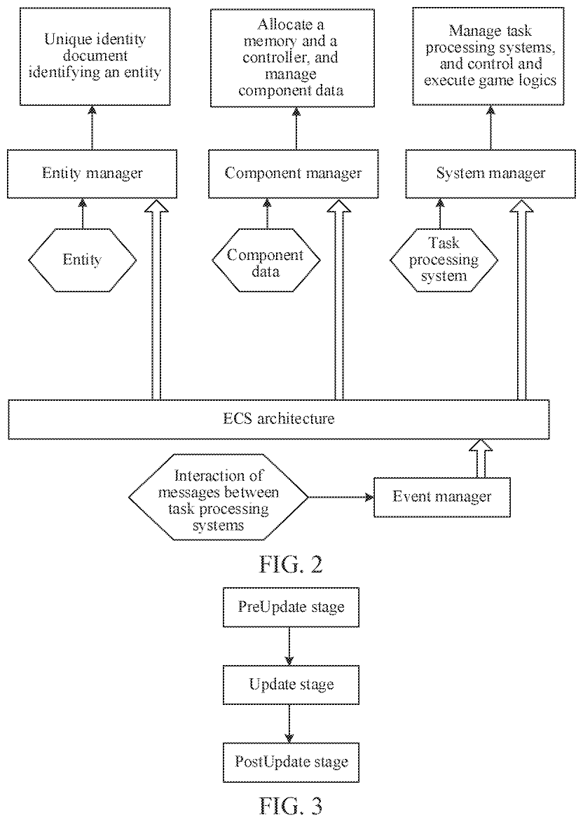

Considering that the game engine generally executes a related processing task in units of game frames during normal running of a game, in the embodiment of this application, processing of one game frame is divided into a preUpdate stage, an Update stage and a postUpdate stage. An execution sequence of the three stages is as shown in FIG. 3, that is, first executing the preUpdate stage, then the Update stage, and finally the postUpdate stage.

In the preUpdate stage corresponding to the game frame, the game engine executes a preparation task required for updating the game frame. For example, a task processing system configured to execute a script logic in the game engine can execute operations of triggering update of an object position, triggering playback of a specific animation effect, and the like. The task processing system configured to execute a physical computing task in the game engine executes an operation of calculating a motion parameter of the virtual element, and the like. In the Update stage corresponding to the game frame, the game engine executes the update task of the game frame. For example, a task processing system configured to execute a rendering task in the game engine can execute a rendering operation on a virtual element, and the like. In the postUpdate stage corresponding to the game frame, the game engine executes a finishing task required for updating the game frame. For example, the task processing system configured to execute the script logic in the game engine can execute a statistical operation on relevant data in the game frame, and the like.

In the case that the divided task processing stage includes a preUpdate stage, an Update stage and a postUpdate stage, when a task processing system is registered in the game engine, a task processing stage is correspondingly configured for the task processing system according to execution timing of a task to be processed by the task processing system. For example, for the task processing stage for executing a rendering task, the corresponding task processing stage is configured as the Update stage. For the task processing system configured to execute a physical computing task, the corresponding task processing stage is configured as the preUpdate stage. For the task processing system configured to execute a script logic, the corresponding task processing stage is configured as the preUpdate stage and the postUpdate stage.

It is to be understood that one or more task processing stages can be configured for one task processing system according to executing timing of a task to be processed by the task processing system. The number of task processing stages corresponding to on task processing system is not limited in this application.

Therefore, dividing task processing stages according to processing of a game frame, and correspondingly configuring task processing stages for task processing systems can ensure that configuration of the task processing stages for the task processing systems is reasonably. Moreover, configuring running association relationships for the task processing systems provides better basic conditions for configuration, and the specific applicable timing of the configured running association relationships can be clarified.

In the embodiment of this application, other than configuring the task processing stages for the task processing systems, running association relationships of the task processing systems in the corresponding task processing stages are also configured for the task processing systems. The running association relationship is used for representing a running dependency relationship between the task processing system and other task processing systems in the game engine. Exemplarily, if a task processing system A needs to, depending on a processing result of a task processing system B, execute a task to be processed by the task processing system A in a task processing stage corresponding to the task processing system A, a running association relationship used for representing that the task processing system A needs to execute the task depending on the processing result of the task processing system B is configured for the task processing system A. Therefore, each task processing system is provided with a running association relationship of the task processing system in a corresponding task processing stage, and thus the task scheduling system can reasonably allocate, according to the running association relationship, a processing thread for a task generated by the task processing system in the task processing stage.

It is to be understood that if a certain task processing system does not have a running dependency relationship with other task processing systems in a corresponding task processing stage, that is, the task processing system can independently execute the task to be processed by the task processing system, without depending on processing results of other task processing systems, a running association relationship used for representing that the task processing system does not need to depend on other task processing systems is configured for the task processing system. Running association relationships configured for task processing systems are not limited in this application.

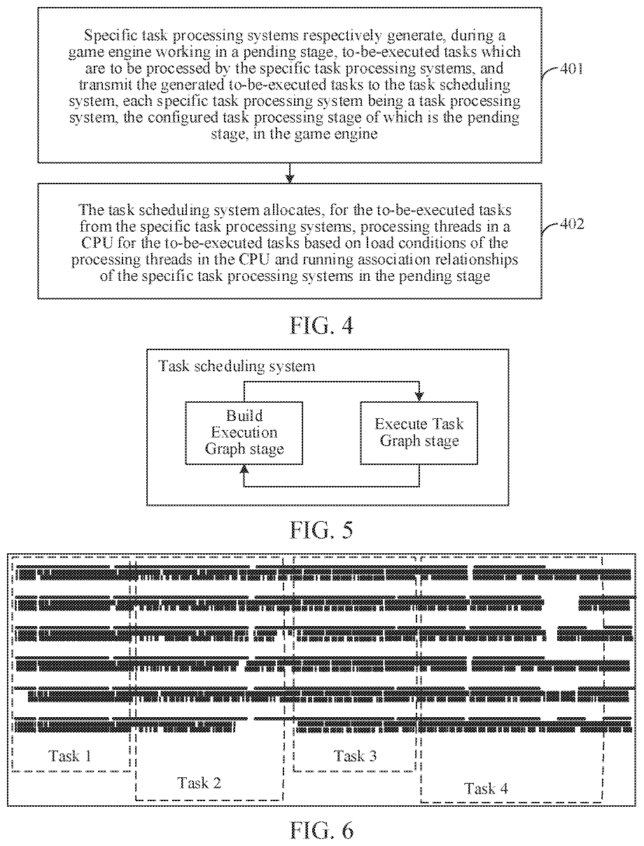

After understanding the applicable game engine and basic information configured for task processing systems in the game engine in the embodiment of this application, a task scheduling method according to the embodiment of this application is described in detail in the following method embodiments. With reference to FIG. 4, FIG. 4 is a schematic flowchart of a task scheduling method according to an embodiment of this application. As shown in FIG. 4, the task scheduling method includes the following steps:

Step 401: Generate, respectively by specific task processing systems during the game engine working in a pending stage, to-be-executed tasks which are to be processed by the specific task processing systems, and transmit the to-be-executed tasks to the task scheduling system, each specific task processing system being a task processing system a configured task processing stage of which is the pending stage in the game engine.

In a running process of a game, the specific task processing systems in the game engine respectively generate, during the game engine working in the pending stage, the to-be-executed tasks which are to be processed by the specific task processing systems, and transmit the to-be-executed tasks to the task scheduling system in the game engine. Each specific task processing system is a task processing system a configured task processing stage of which is the pending stage in the game engine.

Exemplarily, assuming that in the embodiment of this application, the task processing stages are divided according to processing of a game frame, and include a preUpdate stage, an Update stage and a postUpdate stage, during the game engine working in a preUpdate stage corresponding to a certain game frame, i.e., during the game engine working in a stage for executing a preparation task required for updating the certain game frame, task processing systems task processing stages of which are the preUpdate stage in the game engine are all specific task processing systems, and at this time, these specific task processing systems need to correspondingly generate to-be-executed tasks which are to be processed by the specific task processing systems, and transmit the generated to-be-executed tasks to the task scheduling system. For example, the task processing systems task processing stages of which are the preUpdate stage in the game engine include a task processing system A, a task processing system B and a task processing system C. During the game engine working in the preUpdate stage corresponding to a certain game frame, the task processing system A, the task processing system B and the task processing system C are considered as specific task processing systems, and respectively generate a to-be-executed task a, a to-be-executed task b and a to-be-executed task c. The task processing system A transmits the to-be-executed task a generated by the task processing system A to the task scheduling system. The task processing system B transmits the to-be-executed task b generated by the task processing system B to the task scheduling system. The task processing system C transmits the to-be-executed task c generated by the task processing system C to the task scheduling system.

It is to be understood that in actual application, the quantity of the specific task processing system applicable to the pending stage may be one, or may also be more than one. The quantity of the specific task processing systems working in the pending stage in the game engine is not limited in this application.

In one possible implementation, in the embodiment of this application, convenient application programming interfaces (APIs) are provided for the task processing systems, so that the task processing systems can transmit, by means of the APIs, tasks generated by the task processing systems to the task scheduling systems in the game engine. That is, after generating the to-be-executed tasks which are to be processed by the specific task processing systems, the specific task processing systems can transmit, by means of the APIs according to the embodiment of this application, the generated to-be-executed tasks to the task scheduling system.

In the embodiment of this application, on the basis of newly adding the task scheduling system in the game engine, the APIs configured to support communications of the task processing systems with the task scheduling system are further configured for the task processing systems in the game engine. Exemplarily, respective APIs may be configured for the task processing systems in the game engine, and the API corresponding to each task processing system is dedicated to supporting communications between the task processing system and the task scheduling system. Or, one API may be configured for a plurality of task processing systems in the game engine, and the API can support communications between these task processing systems with the task scheduling system. A configuration manner of an API is not limited in this application.

After the APIs are configured for the task processing systems in the game engine, once the task processing systems generate tasks required to be processed, the task processing systems can transmit, by means of the APIs, the generated tasks to the task scheduling system. Therefore, convenience of communications between the task processing systems and the task scheduling system is improved, and each task processing system transmits, by means of an API, a task generated by the task processing system to the task scheduling system, without considering the complex dependency relationship of the task processing system and other task processing systems.

Step 402: Allocate, by the task scheduling system for the to-be-executed tasks from the specific task processing systems, processing threads in a CPU for the to-be-executed tasks based on load conditions of the processing threads in the CPU and running association relationships of the specific task processing systems in the pending stage.

After receiving the to-be-executed tasks transmitted from the specific task processing systems, the task scheduling system respectively allocates the processing threads in the CPU for the to-be-executed tasks based on the current load conditions of the processing threads in the CPU, which supports running of the game, and the running association relationships of the specific task processing systems in the pending stage.

Exemplarily, assuming that the task scheduling system receives the to-be-executed task a, the to-be-executed task b and the to-be-executed task c respectively transmitted from the task processing system A, the task processing system B and the task processing system C, the task scheduling system respectively allocates corresponding processing threads for the to-be-executed task a, the to-be-executed task b and the to-be-executed task c based on load conditions of the processing threads in the CPU, which currently supports running of the game, and running association relationships of the task processing system A, the task processing system B and the task processing system C in the current pending stage. For example, assuming that the task processing system B, in the pending stage, needs to depend on the processing result of the task processing system A to execute the to-be-executed task b to be processed by the task processing system B, and the task processing system C, in the pending stage, does not need to depend on a processing result of another task processing system, the task scheduling system can first respectively allocate processing threads for the to-be-executed task a and the to-be-executed task c, then estimate load conditions of processing threads in the CPU after the to-be-executed task a is finished, and on this basis, allocate a processing thread for the to-be-executed task b.

As described above, the game engine further includes entities corresponding to virtual elements in the game, and the entities include component data. The component data is used for describing function attributes included in the virtual elements corresponding to the entities. The component data included in each of the entities is configured with an identity document (ID) of the entity. In the game engine based on the architecture, when generating the to-be-executed tasks, the specific task processing systems further need to determine, according to the component data included in the entities in the game engine, entities related to the to-be-executed tasks which are to be processed by the specific task processing systems as task entities, and transmit IDs of the task entities to the task scheduling system. Correspondingly, the task scheduling system further needs to transmit, after allocating the processing threads for the to-be-executed tasks from the specific task processing systems, the IDs of the task entities to the allocated processing threads, to cause the processing threads to acquire, based on the IDs of the task entities, the component data included in the task entities to execute the to-be-executed tasks. There may be one or more types of component data included in the entities, which is not limited in the embodiments of this application.

Exemplarily, assuming that a specific task processing system is a task processing system configured to realize a moving function, when the specific task processing system generates a to-be-executed task, the specific task processing system traverses the entities included in the game engine, to find an entity having component data related to the moving function as a task entity, and transmits an ID of the task entity to the task scheduling system by means of a corresponding API. After allocating the processing thread for the to-be-executed task transmitted from the specific task processing system, the task scheduling system can provide the ID of the task entity transmitted from the specific task processing system for the allocated processing thread. Therefore, the processing thread can determine, according to the ID of the task entity when executing the to-be-executed task generated by the specific task processing system, component data on which the execution of the to-be-executed task is based, and based on the component data related to the moving function included in the task entity, realizes the moving function of a virtual element corresponding to the task entity, for example, determining the position of the virtual element corresponding to the task entity after moving.

When determining the task entity, the specific task processing system traverses all entities included in the game engine. All the entities related to the to-be-executed task which is to be processed by the specific task processing system in the game engine are considered as task entities.

In actual application, the specific task processing system may transmit the to-be-executed task to the task scheduling system and simultaneously transmit the ID of the task entity, or may also transmit the ID of the task entity after finishing transmission of the to-be-executed task, or may also transmit the to-be-executed task after transmitting the ID of the task entity. The transmission sequence of the to-be-executed task and the ID of the task entity is not limited in this application.

Therefore, in the game engine based on the ECS architecture, by the foregoing manner, determining component data required to be processed of a to-be-executed task and executing the to-be-executed task based on the determined component data ensure the integrity of task execution, and realize flexible calling of component data in a game engine and flexible control of a virtual element corresponding to an entity.

In one possible implementation, when a task processing system is registered in a game engine, a priority is further configured for the task processing system. The priority is determined based on a degree of importance of a task to be processed by the task processing system, and/or a processing resource to be occupied by the task to be processed by the task processing system. In this case, when allocating the processing threads for the to-be-executed tasks from the specific task processing systems, the task scheduling system can allocate the processing threads in the CPU for the to-be-executed tasks based on the load conditions of the processing threads in the CPU, the priorities corresponding to the specific task processing systems, and the running association relationships of the specific task processing systems in the pending stage.

It is to be understood that when a task processing system is registered in the game engine, a priority is configured for the task processing according to a degree of importance of a task to be processed by the task processing system, and/or a processing resource to be occupied by the task to be processed by the task processing system. The more important the task to be processed by the task processing system is and the more processing resources are required to be occupied, the higher the priority of the task processing system is.

Exemplarily, in the game engine, a task processing system configured to process a rendering task generally consumes more processing resources when executing the rendering task, and the rendering task is important for overall implementation of the game. Therefore, a high priority is configured for the task processing system configured to process the rendering task. A task processing system configured to process a particle effect and a task processing system configured to process a sound effect generally consume less processing resources when executing the tasks, and the particle effect and the sound effect have lower degrees of importance for overall implementation of the game. Therefore, lower priorities are configured for the task processing system configured to process the particle effect and the task processing system configured to process the sound effect. It is to be understood that the configuration manner of the priorities of the task processing systems is merely an example. In actual application, the priorities are configured for the task processing systems according to actual running conditions of the game engine. The configuration manner of priorities is not limited in this application.

In the case that the priorities are configured for the task processing systems in the game engine, when allocating the processing threads for the to-be-executed tasks from the specific task processing systems, the task scheduling system further needs to comprehensively consider the priorities respectively corresponding to the specific task processing systems. For example, a processing thread having better performance and/or lower resource occupancy is allocated for a to-be-executed task from a specific task processing system having a high priority.

As an example, in response to the CPU being a heterogeneous multi-core CPU, the task scheduling system allocates, for a specific task processing system having a priority higher than a first preset level, a processing thread, running of which is supported by an optimal core in the CPU, for the to-be-executed task from the specific task processing system. The optimal core is a core having optimal processing performance in the CPU.

At present, CPUs in many terminal devices (for example, a mobile terminal) are composed of a plurality of cores having different sizes and different frequencies, and in order to make the task scheduling method according to the embodiment of this application adapt to such mobile terminals, when allocating processing threads for tasks from task processing systems, a task scheduling system can lock important tasks to execute on cores having better processing performance in the CPU, and tasks having low degrees of importance can be executed on cores having average processing performance in the CPU.

On this basis, a first preset level can be set in advance. A task to be processed by a task processing system having a priority higher than the first preset level is considered as a task having a high degree of importance, and a task to be processed by a task processing system having a priority not higher than the first preset level is considered as a task having a low degree of importance. The task scheduling system allocates, when receiving the task transmitted from the task processing system having the priority higher than the first preset level, a processing thread, running of which is supported by an optimal core in the CPU (i.e., the core having optimal performance in the CPU), for the task. For example, when receiving a rendering task transmitted from a task processing system configured to process the rendering task, the task scheduling system locks the rendering task to execute on a processing thread, running of which is supported by an optimal core. Otherwise, the task scheduling system allocates, when receiving the task transmitted from the task processing system having the priority not higher than the first preset level, a processing thread, running of which is supported by other cores than the optimal core in the CPU, for the task. For example, when receiving a particle effect processing task transmitted from a task processing system configured to process a particle effect, the task scheduling system places the particle effect processing task to execute on a processing thread, running of which is supported by a core having average performance.

It is to be understood that in the case that the processing performance of cores included in the CPU is more diverse, in the embodiment of this application, more diverse priorities can be adaptively configured for task processing systems in the game engine, and more level intervals corresponding to the cores having different processing performance are configured. According to the level intervals to which the priorities of the task processing systems belong, processing cores are configured for tasks from the task processing systems.

Therefore, by the foregoing manner, a task scheduling scheme adaptive to a heterogeneous multi-core CPU is implemented, ensuring that important tasks are placed to execute on cores having better processing performance in a CPU, so that more stable running of a game is ensured.

As an example, in response to the CPU being a homogeneous multi-core CPU, the task scheduling system determines, according to load conditions of processing threads in the CPU, a processing thread having an occupancy rate satisfying a preset condition in the CPU as a preferred processing thread. Furthermore, the task scheduling system allocates, for a specific task processing system having a priority higher than a second preset level, the preferred processing thread for a to-be-executed task from the specific task processing system.

At present, CPUs in many terminal devices (for example, a personal computer) are composed of a plurality of cores having same sizes and same frequencies, when the game engine according to the embodiment of this application runs in such computers, a task scheduling system can allocate processing threads in the CPU for tasks generated by task processing systems based on a load balancing principle of the CPU. For a task from a task processing system having a high priority, the task scheduling system can allocate a processing thread having low occupancy in the CPU for the task in priority.

On this basis, a second preset level can be set in advance. A task to be processed by a task processing system having a priority higher than the second preset level is considered as a task having a high degree of importance, and a task to be processed by a task processing system having a priority not higher than the second preset level is considered as a task having a low degree of importance.

When allocating the processing threads for the to-be-executed tasks from the specific task processing systems, the task scheduling system first determines, according to load conditions of the processing threads in the CPU, which supports running of the game, a processing thread having an occupancy rate satisfying a preset condition in the CPU as a preferred processing thread. Here, the occupancy being lower than a preset threshold can be considered as a preset condition, or the occupancies of the processing threads in the CPU can be sorted in ascending order, and multiple processing threads in the top order are determined as satisfying the preset condition. The preset condition is not limited in this application. Furthermore, the determined preferred processing thread is allocated for the to-be-executed task of the specific task processing system having a priority higher than the second preset level.

Therefore, by the foregoing manner, a task scheduling scheme adaptive to a homogeneous multi-core CPU is implemented, ensuring that important tasks are placed to execute on processing threads having rich processing resources in a CPU, so that more stable running of a game is ensured.

In actual application, the tasks to be processed by the task processing systems may be composed of multiple sub-tasks having associations, that is, the to-be-executed task transmitted by each specific task processing system to the task scheduling system may include a plurality of to-be-executed sub-tasks, and execution association relationships respectively corresponding to the plurality of to-be-executed sub-tasks. Here, the execution association relationships are used for representing an execution dependency relationship between the corresponding to-be-executed sub-task of the execution association relationship and other to-be-executed sub-tasks in the to-be-executed tasks. Here, the task scheduling system configures processing threads for the to-be-executed tasks and the to-be-executed sub-tasks therein by the following manner:

allocating, for the to-be-executed tasks from the specific task processing systems, processing thread sets for the to-be-executed tasks based on the load conditions of the processing threads in the CPU and the running association relationships of the specific task processing systems in the pending stage; and allocating, for each of the to-be-executed tasks, the processing threads in the processing thread set for the to-be-executed sub-tasks in the to-be-executed task based on the load conditions of the processing threads in the processing thread set corresponding to the to-be-executed task and the execution association relationships respectively corresponding to the to-be-executed sub-tasks in the to-be-executed task.

Exemplarily, the to-be-executed tasks generated by the specific task processing systems are actually composed of a plurality of to-be-executed sub-tasks having association relationships. The specific task processing systems transmit the to-be-executed tasks generated by the specific task processing systems to the task scheduling system, that is, actually, transmitting the plurality of to-be-executed sub-tasks in the to-be-executed tasks generated by the specific task processing systems and execution association relationships corresponding to the plurality of to-be-executed sub-tasks to the task scheduling system. Here, the execution association relationship corresponding to the to-be-executed sub-task represents an execution dependency relationship between the corresponding to-be-executed sub-task and other to-be-executed sub-tasks in the to-be-executed tasks. For example, assuming that the execution of a to-be-executed sub-task 1 needs to depend on a processing result of a to-be-executed sub-task 2, an execution association relationship corresponding to the to-be-executed sub-task 1 is generated on this basis.

When allocating processing threads, the task scheduling system can first allocate processing thread sets for received to-be-executed tasks in a game engine level. The allocated processing thread set may include one processing thread, or may include a plurality of processing threads. The implementation of allocating the processing thread sets for the to-be-executed tasks in the game engine level is essentially the same as the implementation of allocating processing threads for to-be-executed tasks described above. For details, please refer to the relevant introduction content above, which is not repeated here.

After allocating the processing thread sets for the to-be-executed tasks, the task scheduling system further allocates processing threads for to-be-executed sub-tasks in the to-be-executed tasks in a task level. In one possible implementation, the task scheduling system allocates the processing threads for the to-be-executed sub-tasks of the to-be-executed tasks according to the corresponding execution association relationships of the to-be-executed sub-tasks in the to-be-executed tasks in combination with current load conditions of the processing threads in the processing thread sets corresponding to the to-be-executed tasks. For example, assuming that a to-be-executed task includes a to-be-executed sub-task 1, a to-be-executed sub-task 2 and a to-be-executed sub-task 3, execution of the to-be-executed sub-task 2 needs to depend on a processing result of the to-be-executed sub-task 1, and the to-be-executed sub-task 3 can be executed independently without depending on a processing result of another to-be-executed sub-task, the task scheduling system first allocates processing threads for the to-be-executed sub-task 1 and the to-be-executed sub-task 3, then estimates load conditions of processing threads in the processing thread set after the to-be-executed sub-task 1 is finished, and on this basis, allocates a processing thread for the to-be-executed sub-task 2.

Therefore, by the foregoing manner, two-level processing resource allocation is realized on two levels, i.e., the game engine level and the task level, which not only ensures reasonable processing resource allocation for each task required to be processed, but also ensures reasonable processing resource allocation for each sub-task in the task, implementing more detailed reasonable allocation of processing resources and further improving CPU parallelism.

In one possible implementation, the to-be-executed sub-tasks in the to-be-executed task also have corresponding priorities, that is, when a specific task processing system generates a to-be-executed task, the specific task processing system configures priorities for to-be-executed sub-tasks according to degrees of importance of the to-be-executed sub-tasks in the to-be-executed task, and/or processing resources to be occupied. In this case, when allocating the processing threads for the to-be-executed sub-tasks in the to-be-executed task, the task scheduling system determines, according to load conditions of processing threads in a processing thread set corresponding to the to-be-executed task, a processing thread having the lowest occupancy rate in a processing thread set. Therefore, the task scheduling system allocates, for a to-be-executed sub-task having a priority higher than a third preset level, the processing thread having the lowest occupancy rate for the to-be-executed sub-task.

When the specific task processing system generates a to-be-executed task, the specific task processing system configures priorities for to-be-executed sub-tasks in the to-be-executed task according to degrees of importance of the to-be-executed sub-tasks in the to-be-executed task, and/or processing resources to be occupied by the to-be-executed sub-tasks in the to-be-executed tasks. It is to be understood that in the to-be-executed task, the higher the degrees of importance in the to-be-executed sub-tasks are and the more processing resources are required to be occupied by the to-be-executed sub-tasks, the higher the priorities corresponding to the to-be-executed sub-tasks are. In the case that the priorities are configured for the to-be-executed sub-tasks in the to-be-executed tasks, when allocating the processing threads for the to-be-executed sub-tasks in the to-be-executed tasks, the task scheduling system further needs to comprehensively consider the priorities respectively corresponding to the to-be-executed sub-tasks. For example, a processing thread having lower resource occupancy in a processing thread set is allocated for a to-be-executed sub-task having a high priority.

Exemplarily, a third preset level can be set in advance. A to-be-executed sub-task having a priority higher than the third preset level is considered as a sub-task having a high degree of importance, and a to-be-executed sub-task having a priority not higher than the third preset level is considered as a task having a low degree of importance. When allocating the processing threads for the to-be-executed sub-tasks in the to-be-executed task, the task scheduling system determines, according to load conditions of processing threads in a processing thread set corresponding to the to-be-executed task, a processing thread having the lowest occupancy rate in a processing thread set. Furthermore, the processing thread having the lowest occupancy rate is allocated for a to-be-executed sub-task having a priority higher than a third preset level.

Therefore, by the foregoing manner, the processing resource allocation manner in the task level is further optimized, such that an important sub-task is executed on a processing thread having low occupancy, and it is ensured that a to-be-executed task can be well executed.

The task scheduling method provides a game engine-level processing resource scheduling manner, that is, in each task processing stage involved in a game running process, running association relationships between tasks generated by the game engine in the task processing stage are comprehensively considered, and on this basis, the processing resources are allocated for the tasks reasonably. The task scheduling method is applied to a game engine built based on an ECS architecture. This game engine decouples processing logics in a game, and respectively execute different tasks by using multiple independent task processing systems. Based on the game engine, this application innovatively configures, for each task processing system in the game engine, an applicable task processing stage of the task processing system, and a running association relationship of the task processing system in the applicable task processing stage, and additionally provides a task scheduling system, which is configured to comprehensively schedule processing resources, in the game engine. During the game engine working in a certain task processing stage, for example, a pending stage, the task scheduling system reasonably allocates, according to a running association relationship of a specific task processing system applicable to the pending stage, processing threads in a CPU to a to-be-executed task generated by the specific task processing system applicable to the pending stage, thereby implementing processing resource configuration based on a game engine level. Therefore, allocating processing resources by comprehensively considering a running dependency relationship between one task processing system and other task processing systems in a game engine can realize overall control on CPU parallelism, so that the frame rate of a game is improved, and heat loss of a CPU is reduced.

In order to further understanding the task scheduling method according to the embodiment of this application, the following exemplarily introduces the task scheduling method.

Considering that tasks in multiple frames are generally required to be executed during running of a game, processing of a game frame in the game is divided into three sages, i.e., a preUpdate stage, an Update stage and a postUpdate stage, in this application. Each task processing system in a game engine determines, according to executing timing of a task to be processed by the task processing system, which stage or which stages of the three stages the task processing system is specifically applicable to, and on this basis, configures a task processing stage corresponding to the task processing system. For example, a task processing system configured to execute a script logic needs to run some script logics (e.g., updating the position of an object, and playing an animation) in the preUpdate stage corresponding to a game frame, and therefore a task processing stage corresponding to the task processing system is configured as the preUpdate stage. For another example, a task processing system configured to execute a rendering task needs to execute computing tasks such as generating a rendering command, and rendering and clipping in the Update stage corresponding to the game frame, and therefore a task processing stage corresponding to the task processing system is configured as the Update stage.

In each stage in the preUpdate stage, the Update stage and the postUpdate stage, task processing systems applicable to the stage can all transmit, by means of respective APIs, the generated to-be-executed tasks to the task scheduling system, such that the task scheduling system allocates processing threads in the CPU for the generated tasks. In addition, a task generated by the task processing system includes multiple sub-tasks, and these sub-tasks may have dependency relationships on each other, or may also be executed arbitrarily. The task processing system specifies, when creating the task, execution association relationships between the sub-tasks included in the task, for example, specifying a preceding sub-task and a succeeding sub-task, etc., and thus transmits the execution association relationships between the sub-tasks to the task scheduling system.

In the embodiment of this application, during a registration stage of each task processing system, running association relationships between the task processing system and other task processing system in the task processing stage applicable to the task processing system are also configured, that is, whether the task processing system needs to depend on a processing result of another task processing system to execute a task, which is to be processed by the task processing, is configured. For example, the task processing system configured to execute a rendering task depends, in the task processing stage applicable to the task processing system, on a processing result of a task processing system configured to execute a physical computing task, and a processing result of a task processing system configured to execute an animation task, and on this basis, a running association relationship of the task processing system configured to execute the rendering task is configured. In addition, in the registration stage of each task processing system, a priority is configured for the task processing system according to a degree of importance of a task to be processed by the task processing system, and/or a processing resource to be occupied by the task to be processed by the task processing system.

Therefore, after the task processing stages applicable to the task processing systems in the game engine, and the running association relationships and the priorities in the applicable task processing stages are specified, the task scheduling system can reasonably arrange tasks to be executed on corresponding processing threads based on the load conditions of the processing threads in the CPU and the priorities and the running association relationships of the task processing systems. In the embodiment of this application, during running of the game, the task scheduling system cyclically executes a Build Execution Graph stage and a Execute Task Graph stage for each game frame in the game, to execute all game tasks in parallel, as shown in FIG. 5.

In addition, considering that a CPU in a mobile terminal and a CPU in a personal computer (PC) are different in architecture, the CPU in the mobile terminal is generally composed of multiple large and small cores having different sizes and different frequencies. On this basis, the task scheduling system cannot simply allocate tasks on processing threads according to a load balancing principle. In this case, in the embodiment of this application, a task generated by a task processing system having a high priority is locked, according to the priori corresponding to the task processing system, to execute on a core having better performance in the CPU. For example, a rendering task is locked to execute on a large core in the CPU. Moreover, particle, sound effect and other tasks can be executed on a small core having slow performance, such that the performance of the game on the mobile terminal is better improved.

The task scheduling method according to the embodiment of this application can reasonably allocate tasks, which are required to be executed, on processing threads, to ensure that the CPU has a high overall utilization. FIG. 6 illustrates occupancy of processing resources of a CPU during running, based on a task scheduling method according to an embodiment of this application, of a game engine. Six horizontal lines respectively represent six different processing threads in the CPU. Regions distributed with vertical patterns on the lines represent that the processing threads corresponding to the lines are used in time periods corresponding to the regions. Regions not distributed with the vertical patterns on the lines represent that the processing threads corresponding to the lines are not used in time periods corresponding to the regions. As shown in FIG. 6, when task 1, task 2, task 3 and task 4 (task 1, task 2, task 3 and task 4 here may be independent tasks, or may be task sets including a plurality of tasks) are executed, there are few regions not distributed with the vertical patterns on each line in FIG. 6, which indicates that the six processing threads in the CPU are fully utilized, and the overall utilization of the CPU is not lower than 70%.

For the task scheduling method described above, this application further provides a corresponding game engine, such that the task scheduling method can be actually applied and implemented.

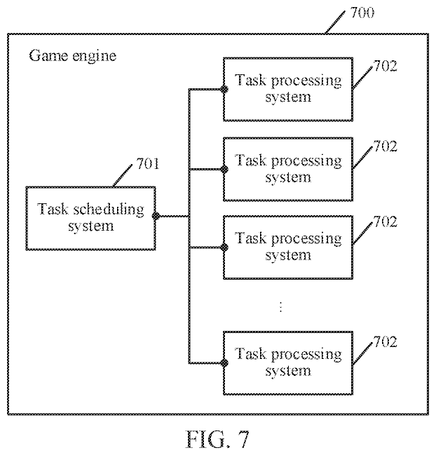

With reference to FIG. 7, FIG. 7 is a structural block diagram of a game engine according to an embodiment of this application. As shown in FIG. 7, a game engine 700 includes a task scheduling system 701 and a plurality of task processing systems 702. Tasks to be processed by the plurality of task processing systems 702 respectively are different. Each task processing system 702 is configured with a corresponding task processing stage and a running association relationship of the task processing system 702 in the corresponding task processing stage. The running association relationship is used for representing a running dependency relationship between the task processing system 702 and other task processing systems 702 in the game engine.

The task processing systems 702 are configured to generate, during the game engine working in the task processing stages corresponding to the task processing systems, tasks which are to be processed by the task processing systems, and transmit the tasks to the task scheduling system 701.

The task scheduling system 701 is configured to allocate, for to-be-executed tasks from specific task processing systems during the game engine working in a pending stage, processing threads in a CPU for the to-be-executed tasks based on load conditions of the processing threads in the CPU and running association relationships of the specific task processing systems in the pending stage. Each specific task processing system is a task processing system a configured task processing stage of which is the pending stage in the game engine, and the to-be-executed task is a task which is generated and to be processed by the specific task processing system.

In one possible implementation, based on the game engine shown in FIG. 7, the game engine further includes a plurality of entities, the entities include component data, and the component data included in each of the entities is configured with an ID of the entity.

The task processing systems 702 are further configured to determine, according to the component data included in the entities in the game engine during the game engine working in the task processing stages corresponding to the task processing systems, entities related to the tasks which are to be processed by the task processing systems, and transmit the IDs of the entities to the task scheduling system 701.

The task scheduling system 701 is further configured to transmit, after allocating the processing threads for the to-be-executed tasks from the specific task processing systems, IDs of task entities to the processing threads, to cause the processing threads to acquire, based on the IDs of the task entities, the component data included in the task entities to execute the to-be-executed tasks. the task entities being entities related to the to-be-executed tasks which are to be processed by the specific task processing systems.

In one possible implementation, based on the game engine shown in FIG. 7, each of the task processing systems 702 is further configured with a priority.

The task scheduling system 701 is specifically configured to allocate, for the to-be-executed tasks from the specific task processing systems, the processing threads in the CPU for the to-be-executed tasks based on the load conditions of the processing threads in the CPU, the priorities corresponding to the specific task processing systems, and the running association relationships of the specific task processing systems in the pending stage.

In one possible implementation, in response to the CPU being a heterogeneous multi-core CPU, the task scheduling system 701 is specifically configured to:

allocate, for a specific task processing system having a priority higher than a first preset level, a processing thread, running of which is supported by an optimal core in the CPU, for the to-be-executed task from the specific task processing system, the optimal core being a core having optimal processing performance in the CPU.

In one possible implementation, in response to the CPU being a homogeneous multi-core CPU, the task scheduling system 701 is specifically configured to:

determine, according to the load conditions of the processing threads in the CPU, a processing thread having an occupancy rate satisfying a preset condition in the CPU as a preferred processing thread; and allocate, for a specific task processing system having a priority higher than a second preset level, the preferred processing thread for the to-be-executed task from the specific task processing system.

In one possible implementation, the priority is determined based on at least one factor of a degree of importance of the task to be processed by the task processing system, and a processing resource to be occupied by the task to be processed by the task processing system.

In one possible implementation, based on the game engine shown in FIG. 7, the to-be-executed tasks include a plurality of to-be-executed sub-tasks and execution association relationships respectively corresponding to the plurality of to-be-executed sub-tasks, and the execution association relationship is used for representing an execution dependency relationship between the corresponding to-be-executed sub-task of the execution association relationship and other to-be-executed sub-tasks in the to-be-executed tasks. The task scheduling system 701 is specifically configured to:

allocate, by the task scheduling system for the to-be-executed tasks from the specific task processing systems, processing thread sets for the to-be-executed tasks based on the load conditions of the processing threads in the CPU and the running association relationships of the specific task processing systems in the pending stage; and

allocate, by the task scheduling system for each of the to-be-executed tasks, the processing threads in the processing thread set for the to-be-executed sub-tasks in the to-be-executed task based on the load conditions of the processing threads in the processing thread set corresponding to the to-be-executed task and the execution association relationships respectively corresponding to the to-be-executed sub-tasks in the to-be-executed task.

In one possible implementation, the to-be-executed tasks further include priorities respectively corresponding to the plurality of to-be-executed sub-tasks. The task scheduling system 701 is specifically configured to:

determine, according to the load conditions of the processing threads in the processing thread set, a processing thread having a lowest occupancy rate in the processing thread set; and allocate, for a to-be-executed sub-task having a priority higher than a third preset level, the processing thread having the lowest occupancy rate for the to-be-executed sub-task.

In one possible implementation, based on the game engine shown in FIG. 7, the task processing stages are divided according to processing of a game frame, and include a preUpdate stage, an Update stage and a postUpdate stage corresponding to the game frame. the preUpdate stage is used for executing a preparation task required for updating the game frame, the Update stage is used for executing an update task of the game frame, and the postUpdate stage is used for executing a finishing task required after the game frame is updated.

In one possible implementation, based on the game engine shown in FIG. 7, the task processing systems 702 are configured to:

generate tasks which are to be processed by the task processing systems, and transmit, by means of APIs, the tasks to the task scheduling system 701.

The task scheduling apparatus provides a game engine-level processing resource scheduling manner, that is, in each task processing stage involved in a game running process, running association relationships between tasks generated by the game engine in the task processing stage are comprehensively considered, and on this basis, the processing resources are allocated for the tasks reasonably. The task scheduling method is applied to a game engine built based on an ECS architecture. This game engine decouples processing logics in a game, and respectively execute different tasks by using multiple independent task processing systems. Based on the game engine, this application innovatively configures, for each task processing system in the game engine, an applicable task processing stage of the task processing system, and a running association relationship of the task processing system in the applicable task processing stage, and additionally provides a task scheduling system, which is configured to comprehensively schedule processing resources, in the game engine. During the game engine working in a certain task processing stage, for example, a pending stage, the task scheduling system reasonably allocates, according to a running association relationship of a specific task processing system applicable to the pending stage, processing threads in a CPU to a to-be-executed task generated by the specific task processing system applicable to the pending stage, thereby implementing processing resource configuration based on a game engine level. Therefore, allocating processing resources by comprehensively considering a running dependency relationship between one task processing system and other task processing systems in a game engine can realize overall control on CPU parallelism, so that the frame rate of a game is improved, and heat loss of a CPU is reduced.

An embodiment of this application further provides a device for implementing the task scheduling method. The device may specifically be a terminal device. The following describes the terminal device according to the embodiment of this application from the perspective of hardware materialization.

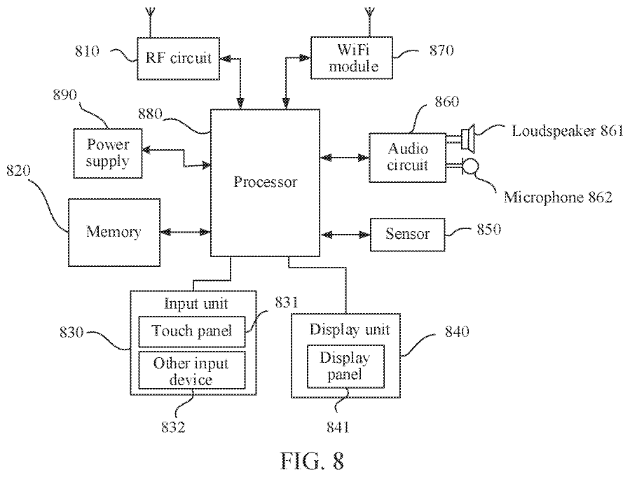

With reference to FIG. 8, FIG. 8 is a structural block diagram of a terminal device according to an embodiment of this application. As shown in FIG. 8, for convenience of explanation, only parts related to the embodiment of this application are shown. For specific technical details not disclosed, reference may be made to the method embodiments of this application. The terminal device may be any terminal device including a mobile phone, a tablet computer, a personal digital assistant (PDA), a point of sales (POS), and a vehicle-mounted computer. Taking the terminal device as a computer as an example,

FIG. 8 a block diagram showing a partial structure of a computer related to a terminal device according to an embodiment of this application. With reference to FIG. 8, the computer includes: a radio frequency (RF) circuit 810, a memory 820, an input unit 830 (including a touch panel 831 and another input device 832), a display unit 840 (including a display panel 841), a sensor 850, an audio circuit 860 (connected to a loudspeaker 861 and a microphone 862), a wireless fidelity (WiFi) module 870, a processor 880, and a power supply 890, etc. A person skilled in the art can understand that the structure of the computer shown in FIG. 8 does not constitute a limitation on the mobile phone, and may include more or fewer parts than those shown in the figure, or include a combination of certain parts, or include different arrangements of parts.

The memory 820 may be configured to store a software program and modules. The processor 880 executes various function applications and data processing of the computer by running the software program stored in the memory 820 and modules. The memory 820 may mainly include a program storage area and a data storage area. The program storage area may store an operating system, an application program that is required by at least one function (for example, a voice playing function and an image playing function), and the like. The data storage area may store data (for example, audio data and an address book) created according to use of the computer, and the like. In addition, the memory 820 may include a high-speed random access memory, and may also include a non-volatile memory, for example, at least one magnetic disk storage device, a flash memory device, or another volatile solid-state storage device.

The processor 880 is a control center of the computer, and uses various interfaces and lines to connect all parts of the entire computer. By running or executing the software program and/or the module that are/is stored in the memory 820 and calling data stored in the memory 820, the processor 880 performs various functions and data processing of the computer, so as to perform overall monitoring on the computer. Optionally, the processor 880 may include one or more processing units. Preferably, the processor 880 may integrate an application processor and a modem processor. The application processor mainly processes an operating system, a user interface, an application program, and the like. The modem processor mainly processes wireless communication. It is to be understood that the foregoing modem processor may alternatively not be integrated into the processor 880.

In the embodiment of this application, the processor 880 included in the terminal device further includes the following functions:

supporting running of a game engine, which includes a task scheduling system and a plurality of task processing systems. Tasks to be processed by the plurality of task processing systems respectively are different. Each task processing system is configured with a corresponding task processing stage and a running association relationship of the task processing system in the corresponding task processing stage. The running association relationship is used for representing a running dependency relationship between the task processing system and other task processing systems in the game engine.

Specific task processing systems generate, respectively during the game engine working in a pending stage, to-be-executed tasks which are to be processed by the specific task processing systems, and transmit the to-be-executed tasks to the task scheduling system. Each specific task processing system is a task processing system a configured task processing stage of which is the pending stage in the game engine.

The task scheduling system allocates, for the to-be-executed tasks from the specific task processing systems, processing threads in a CPU for the to-be-executed tasks based on load conditions of the processing threads in the CPU and running association relationships of the specific task processing systems in the pending stage.

In one possible implementation, the processor 880 is further configured to execute steps of any implementation of the task scheduling method according to the foregoing embodiments of this application.

The embodiment of this application further provides a computer-readable storage medium, configured to store a computer program, the computer program being configured to execute steps of any implementation of the task scheduling method according to the foregoing embodiments.

An embodiment of this application further provides a computer program product or a computer program, the computer program product or the computer program including a computer instruction, which is stored in a computer-readable storage medium. A processor of a computer device reads the computer instruction from the computer-readable storage medium, and executes the computer instruction, to enable the computer device to execute any implementation of the task scheduling method according to the foregoing embodiments of this application.

For the purpose of convenient and brief description, for a specific working process of the foregoing described systems, apparatuses and units, refer to a corresponding process in the foregoing method embodiments. Details are not described herein.

In the several embodiments provided in this application, it is to be understood that the disclosed systems, apparatuses, and methods may be implemented in other manners. For example, the apparatus embodiments described above are merely exemplary. For example, the division of the units is merely the division of logic functions, and other division manners may be used during actual implementation. For example, a plurality of units or components may be combined, or may be integrated into another system, or some features may be omitted or not performed. In addition, the coupling, or direct coupling, or communication connection between the displayed or discussed components may be the indirect coupling or communication connection by means of some interfaces, apparatuses, or units, and may be electrical, mechanical or of other forms.

The units described as separate components may or may not be physically separated, and the components displayed as units may or may not be physical units, and may be located in one place or may be distributed over a plurality of network units. Some or all of the units may be selected based on actual needs to achieve the objectives of the solutions of the embodiments of this application.

In addition, functional units in the embodiments of this application may be integrated into one processing unit, or each of the units may be physically separated, or two or more units may be integrated into one unit. The integrated unit may be implemented in the form of hardware, or may be implemented in a form of a software functional unit.

If implemented in the form of software functional units and sold or used as an independent product, the integrated unit may also be stored in a computer-readable storage medium. Based on such an understanding, the technical solutions of this application essentially, or a part contributing to the related art, or all or a part of the technical solution may be implemented in a form of a software product. The computer software product is stored in a storage medium and includes several instructions for instructing one computer device (which may be a PC, a server, a network device or the like) to perform all or some of steps of the methods in the embodiments of this application. The foregoing storage medium includes any medium that can store program code, such as a USB flash drive, a removable hard disk, a read-only memory (ROM), a random access memory (RAM), a magnetic disk, or an optical disc.

It should be understood that, in this application, “at least one” means one or more, and “a plurality of” means two or more. The term “and/or” describes only an association relationship for describing associated objects and represents that three relationships may exist. For example, “A and/or B” may represent the following three cases: Only A exists, only B exists, and both A and B exist. A may be singular or plural, and B may be singular or plural. The character “/” usually indicates an “or” relationship between the associated objects. “At least one of the following items” or a similar expression means any combination of these items, including a single item or any combination of a plurality of items. For example, “at least one of a, b or c” may represent: a, b, c, “a and b”, “a and c”, “b and c”, or “a and b and c”, where a may be singular or plural, b may be singular or plural, and c may be singular or plural.

The foregoing embodiments are only provided for describing the technical solutions of this application, but not intended to limit this application. Although this application has been described in detail with reference to the foregoing embodiments, a person skilled in the art understands that modifications may still be made to the technical solutions described in the foregoing embodiments, or equivalent replacements may be made to the part of the technical features, and such modifications or replacements do not cause the essence of corresponding technical solutions to depart from the spirit and scope of the technical solutions in the embodiments of this application.

What is claimed is:

1. A task scheduling method, executed by a terminal device, the terminal device being configured to support running of a game engine comprising a task scheduling system and a plurality of task processing systems, tasks to be processed by the plurality of task processing systems respectively being different, each task processing system being configured with a corresponding task processing stage and a running association relationship of the task processing system in the corresponding task processing stage, wherein the running association relationship represents a running dependency relationship between the task processing system and other task processing systems in the game engine, the method comprising:
while the game engine is working in a pending stage:
generating, by specific task processing systems, to-be-executed tasks which are to be processed by the specific task processing systems;
transmitting the to-be-executed tasks to the task scheduling system, wherein each specific task processing system is a task processing system having a configured task processing stage that is part of the pending stage in the game engine; and
allocating, by the task scheduling system for the to-be-executed tasks from the specific task processing systems, processing threads in a central processing unit (CPU) for the to-be-executed tasks based on load conditions of the processing threads in the CPU and running association relationships of the specific task processing systems in the pending stage.

2. The method according to claim 1, wherein the game engine further comprises a plurality of entities, the entities comprise component data, and the component data comprised in each of the entities is configured with an identity document (ID) of the entity; and the method further comprises:
determining, by the specific task processing systems according to the component data comprised in the entities in the game engine, entities related to the to-be-executed tasks which are to be processed by the specific task processing systems as task entities, and transmitting IDs of the task entities to the task scheduling system; and
transmitting, by the task scheduling system after allocating the processing threads for the to-be-executed tasks from the specific task processing systems, the IDs of the task entities to the processing threads, to cause the processing threads to acquire, based on the IDs of the task entities, the component data comprised in the task entities to execute the to-be-executed tasks.

3. The method according to claim 1, wherein each of the task processing systems is further configured with a priority and the method further comprises:
the allocating, by the task scheduling system for the to-be-executed tasks from the specific task processing systems, processing threads in a CPU for the to-be-executed tasks based on load conditions of the processing threads in the CPU and running association relationships of the specific task processing systems in the pending stage comprises:
allocating, by the task scheduling system for the to-be-executed tasks from the specific task processing systems, the processing threads in the CPU for the to-be-executed tasks based on the load conditions of the processing threads in the CPU, the priorities corresponding to the specific task processing systems, and the running association relationships of the specific task processing systems in the pending stage.

4. The method according to claim 3, wherein in response to the CPU being a heterogeneous multi-core CPU, the allocating, by the task scheduling system for the to-be-executed tasks from the specific task processing systems, the processing threads in the CPU for the to-be-executed tasks based on the load conditions of the processing threads in the CPU, the priorities corresponding to the specific task processing systems, and the running association relationships of the specific task processing systems in the pending stage comprises:
allocating, by the task scheduling system for a specific task processing system having a priority higher than a first preset level, a processing thread, running of which is supported by an optimal core in the CPU, for the to-be-executed task from the specific task processing system, the optimal core being a core having optimal processing performance in the CPU.

5. The method according to claim 3, wherein in response to the CPU being a homogeneous multi-core CPU, the allocating, by the task scheduling system for the to-be-executed tasks from the specific task processing systems, the processing threads in the CPU for the to-be-executed tasks based on the load conditions of the processing threads in the CPU, the priorities corresponding to the specific task processing systems, and the running association relationships of the specific task processing systems in the pending stage comprises:
determining, by the task scheduling system according to the load conditions of the processing threads in the CPU, a processing thread having an occupancy rate satisfying a preset condition in the CPU as a preferred processing thread; and
allocating, by the task scheduling system for a specific task processing system having a priority higher than a second preset level, the preferred processing thread for the to-be-executed task from the specific task processing system.

6. The method according to claim 3, wherein the priority is determined based on at least one factor of a degree of importance of the task to be processed by the task processing system, and a processing resource to be occupied by the task to be processed by the task processing system.

7. The method according to claim 1, wherein the to-be-executed tasks comprise a plurality of to-be-executed sub-tasks and execution association relationships respectively corresponding to the plurality of to-be-executed sub-tasks, and the execution association relationship is used for representing an execution dependency relationship between the corresponding to-be-executed sub-task of the execution association relationship and other to-be-executed sub-tasks in the to-be-executed tasks; and
the allocating, by the task scheduling system for the to-be-executed tasks from the specific task processing systems, processing threads in a CPU for the to-be-executed tasks based on load conditions of the processing threads in the CPU and running association relationships of the specific task processing systems in the pending stage comprises:
allocating, by the task scheduling system for the to-be-executed tasks from the specific task processing systems, processing thread sets for the to-be-executed tasks based on the load conditions of the processing threads in the CPU and the running association relationships of the specific task processing systems in the pending stage; and
allocating, by the task scheduling system for each of the to-be-executed tasks, the processing threads in the processing thread set for the to-be-executed sub-tasks in the to-be-executed task based on the load conditions of the processing threads in the processing thread set corresponding to the to-be-executed task and the execution association relationships respectively corresponding to the to-be-executed sub-tasks in the to-be-executed task.

8. The method according to claim 7, wherein the to-be-executed tasks further comprise priorities respectively corresponding to the plurality of to-be-executed sub-tasks; and the allocating, by the task scheduling system, the processing threads in the processing thread set for the to-be-executed sub-tasks in the to-be-executed task based on the load conditions of the processing threads in the processing thread set corresponding to the to-be-executed task and the execution association relationships respectively corresponding to the to-be-executed sub-tasks in the to-be-executed task comprises:
determining, by the task scheduling system according to the load conditions of the processing threads in the processing thread set, a processing thread having a lowest occupancy rate in the processing thread set; and
allocating, by the task scheduling system for a to-be-executed sub-task having a priority higher than a third preset level, the processing thread having the lowest occupancy rate for the to-be-executed sub-task.

9. The method according to claim 1, wherein the task processing stages are divided according to processing of a game frame, and comprise a preUpdate stage, an Update stage and a postUpdate stage corresponding to the game frame; and the preUpdate stage is used for executing a preparation task required for updating the game frame, the Update stage is used for executing an update task of the game frame, and the postUpdate stage is used for executing a finishing task required after the game frame is updated.

10. The method according to claim 1, wherein the generating, respectively by specific task processing systems, to-be-executed tasks which are to be processed by the specific task processing systems, and transmitting the to-be-executed tasks to the task scheduling system comprises:
generating, respectively by the specific task processing systems, the to-be-executed tasks which are to be processed by the specific task processing systems, and transmitting, by means of application programming interfaces (APIs), the to-be-executed tasks to the task scheduling system.

11. A game engine, running on a terminal device, and comprising:
a task scheduling system and a plurality of task processing systems, tasks to be processed by the plurality of task processing systems respectively being different, each task processing system being configured with a corresponding task processing stage and a running association relationship of the task processing system in the corresponding task processing stage, and the running association relationship being used for representing a running dependency relationship between the task processing system and other task processing systems in the game engine;
the task processing systems being configured to generate, during the game engine working in the task processing stages corresponding to the task processing systems, tasks which are to be processed by the task processing systems, and transmit the tasks to the task scheduling system; and
the task scheduling system being configured to allocate, for to-be-executed tasks from specific task processing systems during the game engine working in the pending stage, processing threads in a central processing unit (CPU) for the to-be-executed tasks based on load conditions of the processing threads in the CPU and running association relationships of the specific task processing systems in the pending stage, each specific task processing system being a task processing system a configured task processing stage of which is the pending stage in the game engine, and the to-be-executed task being a task which is generated and to be processed by the specific task processing system.

12. The game engine according to claim 11, wherein the game engine further comprises a plurality of entities, the entities comprise component data, and the component data comprised in each of the entities is configured with an identity document (ID) of the entity;
the task processing systems are further configured to determine, according to the component data comprised in the entities in the game engine during the game engine working in the task processing stages corresponding to the task processing systems, entities related to the tasks which are to be processed by the task processing systems, and transmit the IDs of the entities to the task scheduling system; and
the task scheduling system is further configured to transmit, after allocating the processing threads for the to-be-executed tasks from the specific task processing systems, IDs of task entities to the processing threads, to cause the processing threads to acquire, based on the IDs of the task entities, the component data comprised in the task entities to execute the to-be-executed tasks, the task entities being entities related to the to-be-executed tasks which are to be processed by the specific task processing systems.

13. The game engine according to claim 11, wherein each of the task processing systems is further configured with a priority; and
the task scheduling system is specifically configured to allocate, for the to-be-executed tasks from the specific task processing systems, the processing threads in the CPU for the to-be-executed tasks based on the load conditions of the processing threads in the CPU, the priorities corresponding to the specific task processing systems, and the running association relationships of the specific task processing systems in the pending stage.

14. The game engine according to claim 13, wherein in response to the CPU being a heterogeneous multi-core CPU, the task scheduling system is configured to:
allocate, for a specific task processing system having a priority higher than a first preset level, a processing thread, running of which is supported by an optimal core in the CPU, for the to-be-executed task from the specific task processing system, the optimal core being a core having optimal processing performance in the CPU.

15. A device, comprising a processor and a memory,
the memory being configured to store a computer program; and
the processor being configured to execute, according to the computer program, task scheduling of a game engine on the device, the game engine having a task scheduling system and a plurality of task processing systems, wherein the processor is configured to:
while the game engine is working in a pending stage:
generate, by specific task processing systems, to-be-executed tasks which are to be processed by the specific task processing systems;
transmit the to-be-executed tasks to the task scheduling system, wherein each specific task processing system is a task processing system having a configured task processing stage that is part of the pending stage in the game engine; and
allocate, with the task scheduling system for the to-be-executed tasks from the specific task processing systems, processing threads in the processor for the to-be-executed tasks based on load conditions of the processing threads in the processor and running association relationships of the specific task processing systems in the pending stage.

16. The device according to claim 15, wherein the game engine further comprises a plurality of entities, the entities comprise component data, and the component data comprised in each of the entities is configured with an identity document (ID) of the entity; and the processor is further configured to:
determine, by the specific task processing systems according to the component data comprised in the entities in the game engine, entities related to the to-be-executed tasks which are to be processed by the specific task processing systems as task entities, and transmitting IDs of the task entities to the task scheduling system; and
transmit, by the task scheduling system after allocating the processing threads for the to-be-executed tasks from the specific task processing systems, the IDs of the task entities to the processing threads, to cause the processing threads to acquire, based on the IDs of the task entities, the component data comprised in the task entities to execute the to-be-executed tasks.

17. The device according to claim 15, wherein each of the task processing systems is further configured with a priority and the processor, and wherein to allocate with the task scheduling system for the to-be-executed tasks from the specific task processing systems, the processor is further configured to utilize the priorities as corresponding to the specific task processing systems.

18. The device according to claim 17, wherein the processor comprises a heterogeneous multi-core processor, and the processor is further configured to:
allocate, with the task scheduling system for a specific task processing system having a priority higher than a first preset level, a processing thread, running of which is supported by an optimal core in the processor, for the to-be-executed task from the specific task processing system, the optimal core being a core having optimal processing performance in the processor.

19. The device according to claim 17, wherein the processor comprises a homogeneous multi-core processor, and the processor is further configured to:
determine, with the task scheduling system according to the load conditions of the processing threads in the processor, a processing thread having an occupancy rate satisfying a preset condition in the CPU as a preferred processing thread; and
allocate, by the task scheduling system for a specific task processing system having a priority higher than a second preset level, the preferred processing thread for the to-be-executed task from the specific task processing system.

20. The device according to claim 17, wherein the priority is determined based on at least one factor of a degree of importance of the task to be processed by the task processing system, and a processing resource to be occupied by the task to be processed by the task processing system.
